(19) United States
(12) Patent Application Publication
(10) Pub. No.: US 2008/0313685 A1
(43) Pub. Date: Dec. 18, 2008

(54) METHOD AND SYSTEM FOR RECEIVING CONTENT OVER CONCURRENT MULTICHANNELS

(76) Inventor: Yasantha Nirmal Rajakarunanayake, San Ramon, CA (US)

Correspondence Address: MCANDREWS HELD & MALLOY, LTD, 500 WEST MADISON STREET, SUITE 3400, CHICAGO, IL, 60661, US

(21) Appl. No.: 11/763,831

(22) Filed: Jun. 15, 2007

(51) Int. Cl. H04N 7/173

(52) U.S. Cl. 725/98

(57) ABSTRACT

The disclosed systems and methods may save bandwidth by using concurrent multichannels, which are transmitting separate sections of a file in parallel from server to client. The systems and methods may also be applicable to transmitting and receiving multimedia content (video and audio) for Video on Demand applications (VOD) while minimizing wait time at the client side. Aspects of the present invention may also allow servers to connect simultaneously with a very large number of clients to download large files and essential data.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Video on Demand (VOD) applications may be limited because of the excessive transmission bandwidth needed to provide nearly identical content to thousands of users. Near VOD has been used with limited success, where the same content is transmitted in a time-lapsed fashion, e.g. on 15 minute or 30 minute intervals. Therefore, each user may have to wait up to 15 or 30 minutes if they have just missed their desired program when they tune in. This has driven customers away, who want content to be available truly on demand.

Moreover, a typical 2-hour movie, if made available to users every 15 minutes, will use up 8 times more bandwidth than a single stream since there are 8 distinct 15-minute time slots in the 2 hours. For example if a 3 Mbits per sec movie that is 2 hours in duration is to be made available to users for viewing and the wait time is no more than 15 minutes, prior art solutions would require the transmission of 8 separate streams each spaced 15 minutes apart. This would be a total bandwidth consumption of 24 Mbits per sec, which may be prohibitively expensive for a service provider.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for distributing content over multichannels as shown in and/or described in connection with at least one of the figures, as set forth more completely in the claims. Advantages, aspects and novel features of the present invention, as well as details of an illustrated embodiment thereof, will be more fully understood from the following description and drawings.

### BRIEF DESCRIPTION OF THE DRAWINGS

FIG. 1 is a flowchart illustrating an exemplary method for content transmission using concurrent multichannels in accordance with a representative embodiment of the present invention;

FIG. 2 is a flowchart illustrating an exemplary method for content reception using concurrent multichannels in accordance with a representative embodiment of the present invention;

FIG. 3 illustrates an exemplary splicing of content into four concurrent multichannels in accordance with a representative embodiment of the present invention;

FIG. 4 illustrates an exemplary reception of content on four concurrent multichannels in accordance with a representative embodiment of the present invention; and

FIG. 5 is an illustration of an exemplary system for wired and wireless media reception using concurrent multichannels in accordance with an embodiment of the present invention.

### DETAILED DESCRIPTION OF THE INVENTION

Aspects of the present invention relate to transmitting and receiving multimedia content (video and audio) that may be suitable for Video on Demand applications (VOD). Aspects of the present invention may minimize required transmission bandwidth while meeting specific VOD parameters, such as wait time, at the client side. Aspects of the present invention may also apply to downloading large files and essential data, thereby allowing servers to connect simultaneously with a very large number of clients. The following systems and methods describe an implementation that may save bandwidth by using concurrent multichannels, which are transmitting separate sections of a file in parallel from server to client.

The following systems and methods may use a Packet Identifier (PID) substitution scheme applied to an MPEG2 or AVC transport stream. Although the following description may refer to particular identification schemes and media standards, many other schemes and standards may also use these systems and methods.

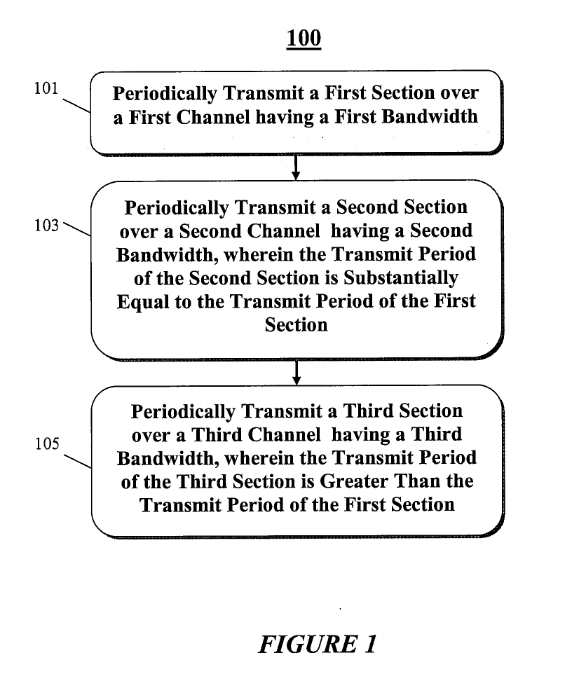

FIG. 1, 100, is a flowchart illustrating an exemplary method for content transmission using concurrent multichannels in accordance with a representative embodiment of the present invention.

The time (T) of an entire file (e.g. movie or other media event), the transmit period (TP) of a section of the file, and the playback time (PB) of a section of the file are divided into units of wait time (W). For example, the playback time of a 12 minute section of a movie with W=9 minutes may be represented as PB=4/3. For illustrative purposes, the primary channel bandwidth is normalized to 1. The number of subchannels, in addition to the primary channel, used in the process is N. The total bandwidth (B) of all the subchannels plus the primary channel is B=1+N*f, where f is the bandwidth of each subchannel. The subchannel bandwidth, f, may be greater than or less than the primary channel bandwidth.

At 101, a first section of the file is transmitted over a first channel having a first bandwidth (normalized to 1). The first section may be repeatedly transmitted using PID0. The transmit period of the first section may be 1 unit (TP=1), and the first section may also represent 1 unit of playback time (PB=1). For example if W=9 minutes, the first section would represent 9 minutes of playing time and would be repeatedly transmitted every 9 minutes.

At 103, a second section of the file is periodically transmitted over a second channel having a second bandwidth. The transmit period of the second section is substantially equal to the transmit period of the first section. The second section may use PID1 and may be transmitted synchronously with the first section. The transmit period of the second section may be 1 unit (TP=1). Since the second bandwidth (f) may be different that the first bandwidth, the second section will represent f units of playback time (PB=f). For example if f=one-third of the first bandwidth and W=9 minutes, the second section would represent 3 minutes of playing time and would be repeatedly transmitted every 9 minutes.

At 105, a third section of the file may be periodically transmitted, with PID2, over a third channel having a third bandwidth. The transmit period of the third section may be greater than the transmit period of the first section. For example, the transmit period of the third section may be 1+f units (TP=1+f). If the third bandwidth is equal to the second bandwidth (f), the third section will represent (1+f)f units of playback time (PB=(1+f)f). For example if f=one-third of the first bandwidth and W=9 minutes, the third section would represent 4 minutes of playing time and would be repeatedly transmitted every 12 minutes.

The method, 100, may be repeated. The (N+1)^{th} section of content may be periodically transmitted as PIDN with TP=(1+f) (N−1) time units and bandwidth, f. The resulting playback time of the (N+1)^{th} section would be PB=(1+f)^{(N-1)}f The entire playback time after the (N+1)^{th}. section is played would be (1+f)^{N}.

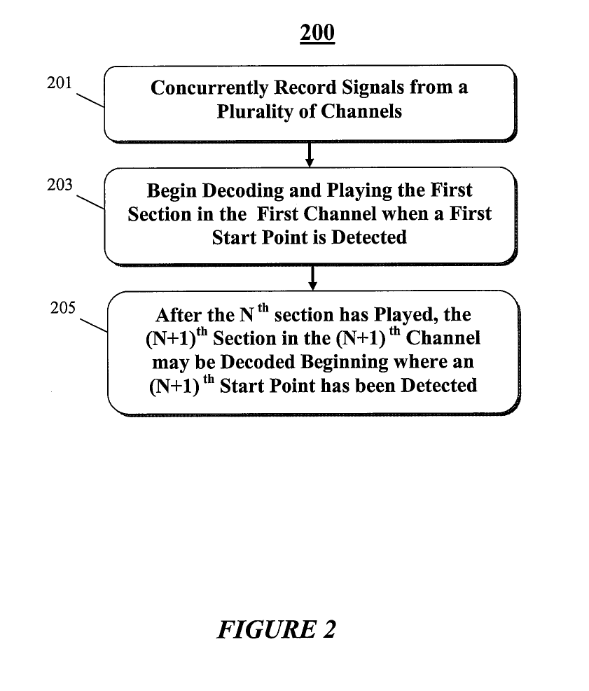

FIG. 2, 200, is a flowchart illustrating an exemplary method for content reception using concurrent multichannels in accordance with a representative embodiment of the present invention.

At 201, signals are concurrently recorded from a plurality of channels, PID0 through PIDN. In one embodiment, the recording is done simultaneously. Recording may begin immediately. As part of the recording process, the start point of each PID is determined and stored.

At 203, decoding of the first section in the first channel may begin when a first start point is detected. During playback, the first section is started from this marked start point. Playback may continue through the end of the received section. If the section is not played in it's entirety, playback may continue by wrapping around to the previously recorded portion of the section.

At 205 after the N^{th} section has played, the (N+1)^{th} section in the (N+1)^{th} channel may be decoded beginning where an (N+1)^{th} start point is detected.

If the media sections are transmitted as described with reference to FIG. 1, content from the first (1+f) time units will have been played after the second section. While the second section plays, PID2 may finish recording content long enough to play another (1+f)*f time units. At the end of playing content from the third section (PID2), the total time elapsed is (1+f)+(1+f)*f=(1+f)². After playing PIDN, the elapsed playback time is:

T=(1+f)^{N} EQUATION 1

and the total bandwidth is:

B=1+N*f EQUATION 2

Combining EQUATION 1 and EQUATION 2 gives:

B=1+N*(T^{(1/N)}−1) EQUATION 3

For example, a waiting time W=15 minutes results in T=8 for a 2-hour movie. TABLE 1 shows bandwidth B against the number of subchannels, N, for T=8.

TABLE 1

| N | f | B |
|---|---|---|
| 2 | 1.83 | 4.66 |
| 4 | 0.68 | 3.73 |
| 20 | 0.11 | 3.19 |
| 100 | 0.02 | 3.10 |

An alternative example may fix B=8 to minimize waiting time. The waiting time, W. (in minutes) for a 120 minute event duration gives T=120/W. TABLE 2 shows the waiting time, W, against the number of subchannels, N, for B=8 (i.e. a bandwidth of 8× the primary channel rate).

TABLE 2

| N | f | W | |
|---|---|---|---|
| 2 | 3.50 | 5.93 | minutes |
| 4 | 1.75 | 2.10 | minutes |
| 20 | 0.35 | 17.81 | seconds |
| 100 | 0.07 | 8.30 | seconds |

As the number of subchannels, N, approaches infinity, B as a function of T is:

B=1+ln(T) EQUATION 4

Alternatively, T as a function of B as N approaches infinity is:

T=exp( B−1) EQUATION 5

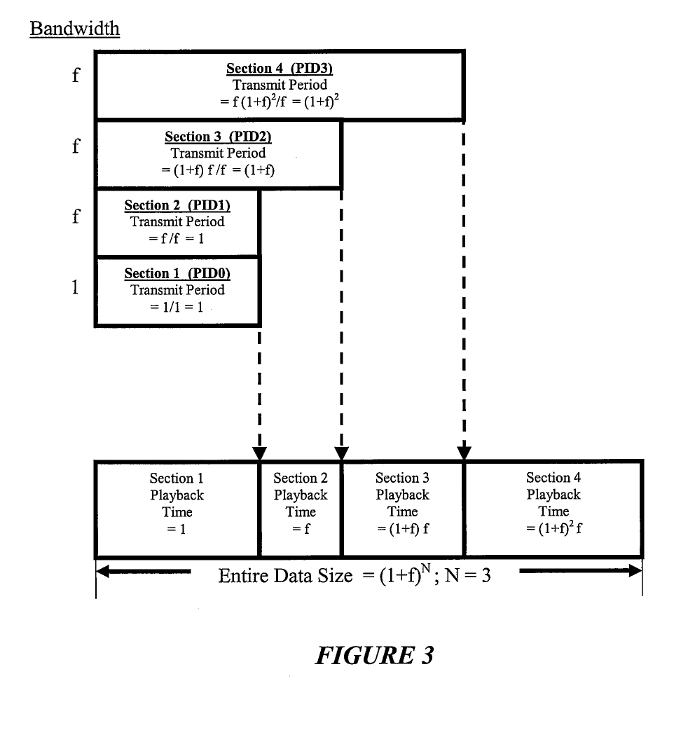

FIG. 3 illustrates an exemplary splicing of media into four concurrent multichannels in accordance with a representative embodiment of the present invention. The relationship between total bandwidth (B), transmit period (TP), playback time (PB), and elapsed time (T) in FIG. 3 is summarized in TABLE 3.

TABLE 3

| Content | B | TP | PB | T |
|---|---|---|---|---|
| First Section | 1 | 1 | 1 | 1 |
| Second Section | f | 1 | f | 1 + f |
| Third Section | f | 1 + f | (1 + f)f | (1 + f)² |
| Fourth Section | f | (1 + f)² | (1 + f)²f | (1 + f)³ |

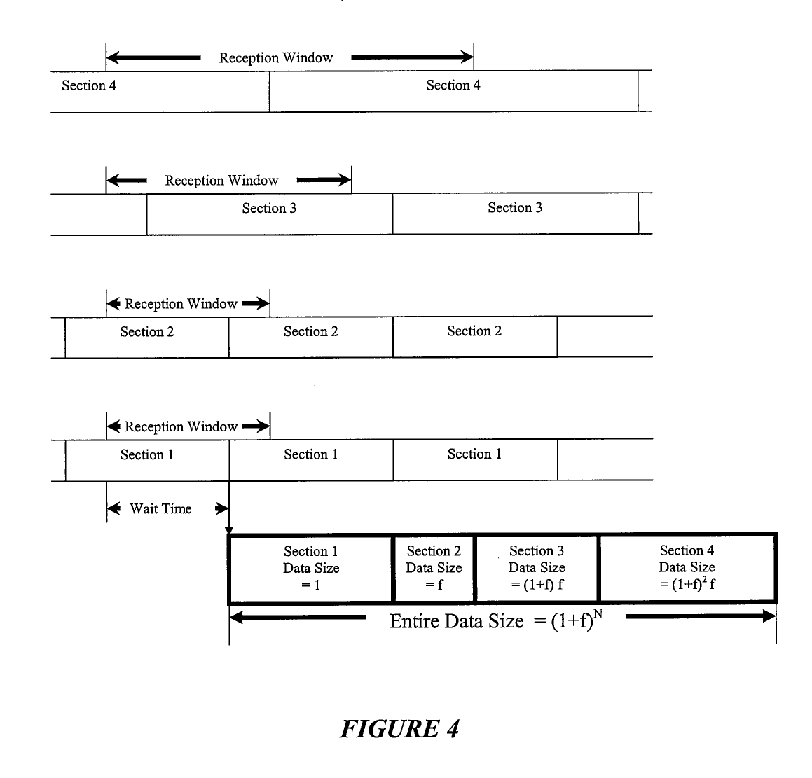

FIG. 4 illustrates an exemplary reception of content transmitted over four concurrent multichannels in accordance with a representative embodiment of the present invention. Decoding of Section 1 may begin when a first start point is detected. Actual wait time is the time between the playback request and the start of playback. When playback reaches the end of the reception window, playing of Section 1 continues with the portion recorded during the wait time.

After Section 1 has played, Section 2 may be decoded beginning where the start point was detected. Content from the first (1+f) time units will have been played when Section 2 has completed. While Section 2 plays, PID2 may finish recording the content of Section 3 in order to have another (1+f)*f time units available to play and avoid any delay during playback. At the end of playing content from Section 3, the total time elapsed is (1+f)². At the end of playing content from Section 4, the total time elapsed is (1+f)³.

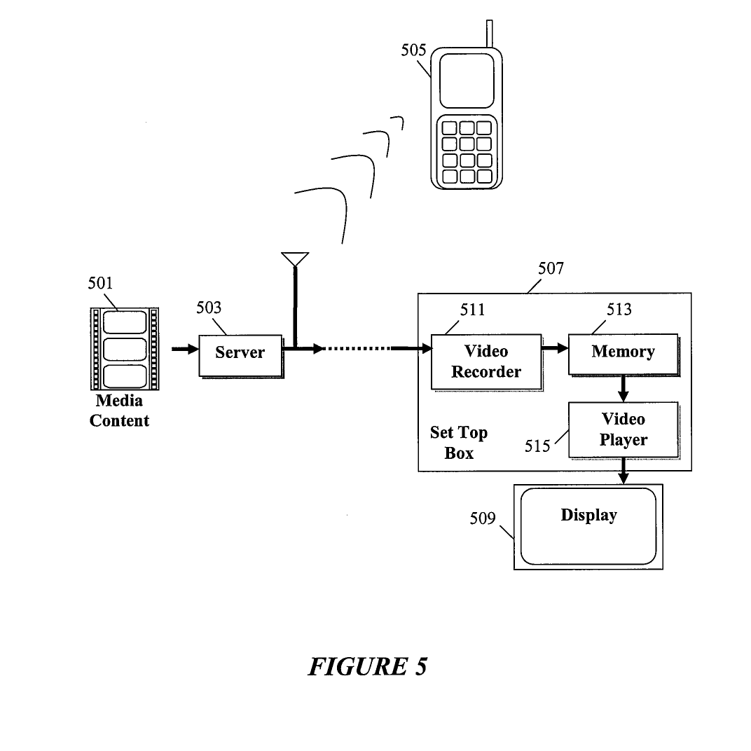

FIG. 5 is an illustration of an exemplary system for wired and wireless media reception using concurrent multichannels in accordance with an embodiment of the present invention. A server, 503, may provide media content, 501, to service wireless or wired customers who request the content at different times.

The server, 503, may provide VOD type services to cellular customers, 505. The server, 503, may also provide digital television broadcast through satellite, over the Internet, or with a cable TV provider. For example, a set top box, 507, may use a video recorder circuit, 511, to record the signals on the incoming multichannels to memory, 513, prior to decoding those signals with a video player circuit, 515. The output of the set top box, 507, will enable a VOD application on a display, 509.

PID translation keeps track of separate multichannels. This method is applicable even if the first section is not the actual content, but related to content (e.g. advertising or previews), which can be pre-downloaded and available in memory. An additional reduction in bandwidth may be achieved if the customers watches this pre-downloaded content.

Some content may be required by a VOD application whenever the VOD application is booted. Application of these methods may reduce the boot-up time of many set-top boxes, which require content (e.g. an operational/program guide) before starting the user interface application (UI).

In the case of IPTV, the separate PID channels could be replaced by the server sending data on separate multicast and/or UDP type broadcast channels. Later sections are downloaded while the previous sections are playing, and more bursty traffic may be tolerated by utilizing additional error correction coding. With this method, it may only be necessary to use RTP for the first section.

This method may improve the streaming of video clips over the Internet. This method may also be used to download large files and essential data. This would allow servers to connect simultaneously to a very large number of clients. For example if a large file requires a 1 GB download and many users are required to connect to the server, server IO capacities and bandwidth will be easily saturated. This method may provide a single instance of IO with multichannels to speed the downloads to a potentially large number of clients, thereby saving server capacity and bandwidth.

The present invention may be realized in hardware, software, or a combination of hardware and software. The present invention may be realized in a centralized fashion in an integrated circuit or in a distributed fashion where different elements are spread across several circuits. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A system for receiving a file over a plurality of channels, wherein the system comprises:
a recorder for concurrently recording a first section of the file and a second section of the file, wherein the first section is transmitted over a first channel and the second section is transmitted over a second channel, and wherein the bandwidth of the first channel is different than the bandwidth of the second channel;
a memory for storing the first section and the second section; and
a circuit for sequentially accessing the first section and the second section.

2. The system of claim 1, wherein the first section and the second section are periodically transmitted to the recorder.

3. The system of claim 2, wherein the periodic transmissions of the first section and the second section are synchronized.

4. The system of claim 1, wherein the recorder records a third section of the file, wherein the third section is transmitted over a third channel, and wherein the bandwidth of the third channel is substantially equal to the bandwidth of the second channel.

5. The system of claim 4, wherein the first section, the second section, and the third section are periodically transmitted to the recorder.

6. The system of claim 5, wherein the transmission period of the first section and the transmission period of the second section are substantially equal, and wherein the transmission period of the third section is longer than the transmission period of the first section.

7. The system of claim 1, wherein the file comprises a digitally encoded media event.

8. The system of claim 7, wherein the circuit decodes the first section of the digitally encoded media event and decodes the second section of the digitally encoded media event.

9. The system of claim 7, wherein the circuit plays the first section of the digitally encoded media event followed by the second section of the digitally encoded media event.

10. The system of claim 1, wherein the plurality of channels are wireless channels.

11. A method for receiving a file over a plurality of channels, wherein the method comprises:
concurrently recording a first section of the file and a second section of the file, wherein the first section is transmitted over a first channel and the second section is transmitted over a second channel, and wherein the bandwidth of the first channel is different than the bandwidth of the second channel; and
sequentially accessing the first section and the second section.

12. The method of claim 11, wherein the first section and the second section are periodically transmitted to the recorder.

13. The method of claim 12, wherein the periodic transmissions of the first section and the second section are synchronized.

14. The method of claim 11, wherein a third section of the file is transmitted over a third channel, and wherein the bandwidth of the third channel is substantially equal to the bandwidth of the second channel.

15. The method of claim 14, wherein the first section, the second section, and the third section are periodically transmitted to the recorder.

16. The method of claim 15, wherein the transmission period of the first section and the transmission period of the second section are substantially equal, and wherein the transmission period of the third section is longer than the transmission period of the first section.

17. The method of claim 11, wherein the file comprises a digitally encoded media event.

18. The method of claim 17, wherein the method further comprises decoding the first section of the digitally encoded media event and decoding the second section of the digitally encoded media event.

19. The method of claim 17, wherein method further comprises playing the first section of the digitally encoded media event followed by the second section of the digitally encoded media event.

20. The method of claim 11, wherein the plurality of channels are wireless channels.
